(19) United States
(12) Patent Application Publication
(10) Pub. No.: US 2017/0132668 A1
(43) Pub. Date: May 11, 2017

(54) METHODS FOR POSTING AVAILABILITY OF A TRUCKER

(71) Applicant: Charles F. Myers, Midlothian, VA (US)

(72) Inventor: Charles F. Myers, Midlothian, VA (US)

(21) Appl. No.: 14/933,849

(22) Filed: Nov. 5, 2015

(51) Int. Cl. G06Q 30/02; H04L 29/08; G06F 17/30; H04W 4/02

(52) U.S. Cl. CPC G06Q 30/0277; G06Q 30/0276; H04W 4/021; H04L 67/306; G06F 17/30867; G06F 17/30554

(57) ABSTRACT

A computer-implemented method to advertise services from a trucker to an online environment with minimal user intervention includes capturing trucker data to be sent periodically with a one-click button, wherein the trucker data includes load and geo-fence data; generating a test advertisement to validate the data to be advertised and activating a “one-click” feature to initiate an automatic advertisement generation; and when the trucker clicks the button, broadcasting the automatically generated advertisement on behalf of the trucker.

### BACKGROUND

The present application relates to transportation management and indicia of truck availability.

Driving a truck is a demanding job. Truckers spend weeks at a time on the road, then after having completed their trip, they spend a few days home. Controlling a truck and trailer that he or she is operating may be one of the biggest physical challenges of the job. Truckers may be expected to work up to 70 hours over an eight-day period and then cannot drive again until they take a full 34 hours off duty. Some drivers are paid hourly, but in most cases compensation is calculated by the mile. A driver does not normally get paid when he or she is not on the road delivering freight. Thus, truck drivers are always looking for loads that best fit their operational needs.

In a parallel trend, one of the greatest challenges for an independent owner-operator or small fleet owner (capacity owner) is finding loads. The capacity owner will generally use a public load service called a load board to search for and find loads. Loads are generally put on the load board by a shipper or freight broker (freight owners) who is seeking the services of an available truck or capacity owner to move the freight posted on the load board. Many times the truck or capacity owner will find a load and will call the freight owner and attempt to book the load in question. Many times the load is already booked and the truck or capacity owner will have to go back to the load board, initiate another load search, find another load and call the freight owner to attempt to book the load. This process can be repeated several times before the truck or capacity owner is successful in booking a load.

### SUMMARY

In one aspect, systems and methods are disclosed for providing a one click button to advertise to customers that a nearby trucker is available to pick up loads.

Advantages of the system may include one or more of the following. The system enables a truck driver to conveniently broadcast to customers and brokers that he/she is available to pick up loads. With a single click, the trucker can provide his/her available, complete with truck profiles, so that shippers can easily locate the trucker. The system also automatically notifies the truck driver of nearby loads that need to be picked up. A geolocation module is installed on a truck driver device (e.g., a mobile phone) and computes the proximity of the truck driver device to the position of the load. When certain criteria are met (e.g., proximity to the position of the load, anticipated time of arrival at the position of the load, etc.), the truck driver can be automatically notified of the nearby position of the load. For example, if the truck driver (and truck driver device) is at a 1-mile distance for the position of the load, a notification can be triggered to the truck driver (the truck driver device), which indicates additional information about the position of the load, for example. In another example, by processing the geolocation information it is computed that the truck driver is approaching the position of the load at a certain velocity, the time of arrival at the position of the load and/or a virtual notification perimeter (e.g., geo-fence) can trigger the notification to the truck driver (device).

The truck driver can define work that he/she is interested in. For example, the button can post relevant information about truck capacity, pricing, destination and categories of the load, such as those needing refrigeration or flat-bed capacity, for example. Accordingly, when the truck driver's device is within a predefined proximity of customer requiring a flat bed truck, these customer locations are highlighted for the driver.

### BRIEF DESCRIPTION OF THE DRAWINGS

FIG. 1 illustrates a block diagram of an exemplary process that facilitates automatically generating a trucker advertisement for online posting and/or listing.

FIG. 2 is a network diagram depicting an online shipping service transaction processing system for an automated transportation marketplace.

FIG. 3 shows an exemplary system to capture truck profiles for the marketplace load book.

FIG. 4 illustrates a block diagram of an exemplary system that facilitates listing a portion of data from a device to an online community network.

FIG. 5 illustrates a block diagram of an exemplary system that facilitates automatically generating an advertisement that is exposed to the Internet based at least in part upon positioning and sensor data captured by a device.

FIG. 6 illustrates an exemplary methodology that facilitates annotating and selectively listing a portion of data online for advertisement.

FIG. 7 illustrates further aspects of the method of FIG. 6.

FIG. 8 illustrates a block diagram of a computing system that supports a post-my-truck button in accordance with one aspect of the invention.

### DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

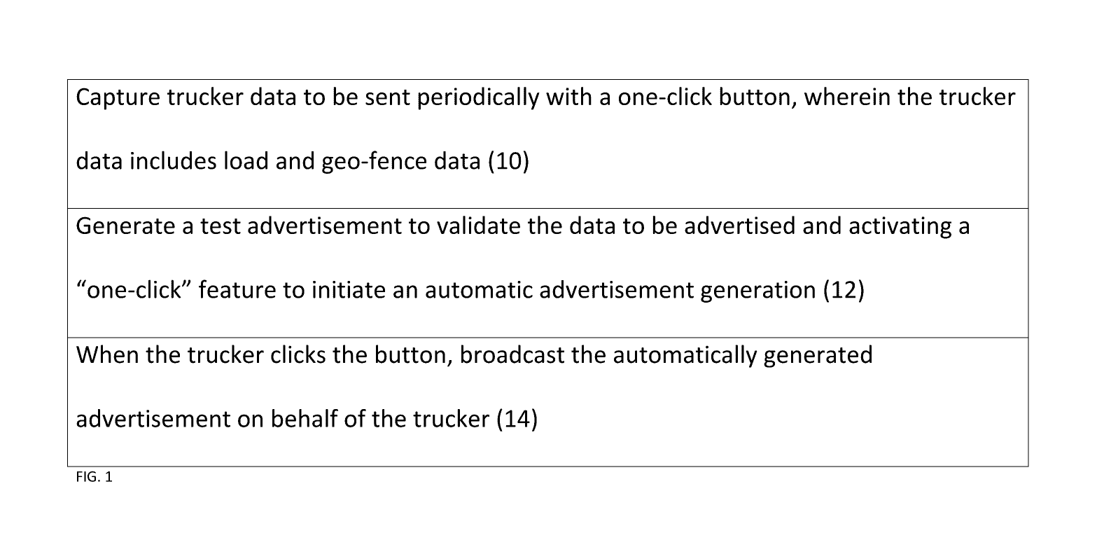

FIG. 1 illustrates a process that automatically generates with one click a post-my-trucklisting, posting, or advertisement. The system receives in advance input from the truck driver as to the information to be posted in the future with the one click. The truck driver can define categories of desired loads, such as those needing refrigeration or flat-bed capacity, for example. Accordingly, when the truck driver pushes the one click button, the advertisement is customized to the desired load prior to transmission. The desired load information associated with the truck driver can be obtained (learned) by various ways, for example, by tracking truck drivers interests as determined by accessing websites and web pages, truck driver profile information, and so on.

Referring to FIG. 1, the process includes capturing trucker data to be sent periodically with a one-click button, wherein the trucker data includes load and geo-fence data (10); generating a test advertisement to validate the data to be advertised and activating a “one-click” feature to initiate an automatic advertisement generation (12). When the trucker clicks the button, broadcasting the automatically generated advertisement on behalf of the trucker (14). In this manner, the process of FIG. 1 supports automatically generating a message to be broadcasted with a one-click from the trucker. When utilizing proximity as a criteria, the proximity relative to a position of the load can be determined according to geo-fencing. A geo-fence is a predefined virtual perimeter (e.g., within a two mile radius of a position of the load) of a physical geographic area. The truck location (truck driver device) can be determined and obtained using geo-location technologies such as global positioning system (GPS), cell tower systems (triangulation), Wi-Fi™ (used to certify the interoperability of wireless computer networking devices) access points, the mobile operator, and so on. The geographical location information of points of interest can also be updated to include new points of interest that are automatically mapped to the category of interest. The new points of interest can be associated with changes in time and location.

Note that the system described herein can process multiple one-click buttons concurrently to post listings or advertisements for the trucker associated with different categories of interest. For example, the geolocation of the truck driver device can trigger notifications for frozen food loads as well as cold temperature medical supply, both of which relate to transportation of low temperature materials but medical loads may be more profitable to the trucker in this example.

The trucker information can include a location tracking component such as a GPS that tracks geographical location of the device relative to categories of geographical points of interest. The location information can be updated as to changes in location of existing points of interest and updated with new points of interest. A notification component queries the repository based on the geographical location of the device and presents a notification via the device based on proximity of the device to points of interest. The system can further comprise a definition component via which the category of interest is specified. The definition component can store information on the type of load transported in the past.

The process can include an automatic posting module that can create published data (e.g., a transportation related advertisement, a truck listing, a posting or an ad for available trucking service, etc.) based at least in part upon GPS and vehicular sensor data received via an interface component 106 (discussed in more detail below), wherein such published data 104 can be automatically published in a specific format to any suitable environment (e.g., the Internet, a network, a networked community, a forum, a website, a blog, an email list server, an email address, a social network, a server, a group, a user, a company, a business, etc.). It is to be appreciated that sensor data can include image data, a graphic, a video, a portion of video, etc. In particular, the automatic posting component 102 can receive a portion of GPS, sensor, or image data that can be utilized to automatically generate an advertisement and/or a listing to be published for exposure with minimal user interaction. For instance, a user can employ a “one-click” technique to capture position data or image data (e.g., picture, video, etc.) related to a truck shipping service and create a published advertisement and/or listing associated with such service. Furthermore, the automatic posting component 102 can enable the advertisement and/or listing based on the portion of image data to be selectively distributed to an environment for limited exposure. For example, rather than publishing the automatically generated listing and/or advertisement to the entire Internet, a particular group of users can be identified for distribution. Ideally, the distribution list should be related to the shipping job being solicited so that the message can be highly focused on getting trucking jobs for the user.

In other words, the automatic posting operation can enable the creation of advertisements and/or listings related to trucking services with a “one-click” technique. The “one-click” technique provides the capturing of truck data or imagery and the generation of an advertisement and/or listing with information to aid in describing the trucking service. For example, the automatic posting component 102 can be utilized in connection with any suitable device that can capture an image (discussed in more detail below) or a plurality of images (e.g., video clip, portion of video, etc.), wherein such device can employ a “one-click” feature that publishes the image and additional data describing such image for exposure to a particular environment (e.g., the Internet, a social network, a network, a networked community, a forum, a website, a blog, an email list server, an email address, a server, a group, a user, a company, a business, etc.). An automatic posting module receives truck data (e.g., positioning data, still picture data, video data, etc.) to base the creation of an advertisement or a listing of truck services with descriptive data, wherein the advertisement can be published to an environment in order to initiate a transaction with minimal user interaction. For instance, the automatic posting unit can employ a “one-click” feature that enables position data, along with an image or a plurality of images (e.g., video, etc.) to be captured, descriptive data to be generated, and an advertisement for such image(s) to be created and published online to an environment in order to entice potential customers of trucking services to participate in a transaction. In addition, it is to be appreciated that the “one-click” feature need not be a “click” activation but rather can be any suitable activation such as, but not limited to, a button, a voice command, a switch, a touch-button, a touch-screen activation, a motion detection activation, a timer delayed switch/button, a slider, etc.

The automatic posting module can populate data and identify a portion of descriptive data related to the trucker. For example, the populate process can identify descriptive data by at least one of the following: receiving audio input from a user and converting such speech to text; dynamically extracting key words from text and filling appropriate fields; or using pattern recognition on the received image data. It is to be appreciated that the descriptive data can be text, additional images, contact information, rating from other customers and fellow truckers, transaction history and details, shipping information, instruction manuals, supporting shipping service details, pricing details, terms of sale, seller information, geographic data, profile data, listing field data, or any suitable data related to the trucking services, etc. Furthermore, the populate component 202 can utilize a service that can provide descriptive data. For example, image data can be received and the populate component 202 can utilize a service to provide descriptive text and transaction data (e.g., terms, price, shipping, etc.) for the advertisement in an aesthetically pleasing format/layout. In addition, such service can be associated with the target environment (e.g., the environment to which the advertisement is to be published) to further simplify posting data online.

The automatic posting module can further utilize an exclusivity component 204 that can selectively identify entities (e.g., users, businesses, groups, machines, computers, websites, networks, servers, email addresses, user profiles, etc.) to expose the generated trucker broadcast or advertisement within the target environment. In other words, the exclusivity module can limit and/or broaden the distribution and/or publication of the advertisement and/or listing. Conventionally, advertisements are distributed to all users and advertisers pay on a per-click basis. The module can automatically post an advertisement to a specific group of users within an environment (e.g., the Internet, a social network, a network, a networked community, a forum, a website, a blog, an email list server, an email address, a server, a group, a user, a company, a business, etc.). For instance, a user can advertise just to a select group of customers or brokers within a certain radius of the current position.

In one embodiment, the automatic posting module can automatically generate an advertisement and/or listing with descriptive data based upon image data (e.g., picture data, video data, etc.), wherein the advertisement and/or listing can be published online (e.g., published data) to an environment. The automatic posting can receive a portion of an image and create an advertisement and/or posting related to such image including descriptive text, terms, price, etc. with the implementation of a “one-click” feature. In other words, the automatic posting can capture an image, abstract information associated with the image, and publish the image with annotated data as an advertisement online in an environment with “one-click” and/or one activation/operation. Additionally, the automatic posting can include a plurality of settings and/or configurations related to publishing (e.g., time, amount, duration, etc.), target environment, terms of sale, negotiations, information to describe the image, pricing, audience to expose, user identification (e.g., profiles, location, etc.), geographic data, privacy settings related to published data, templates, and the like which can be determined automatically, manually, and/or any suitable combination thereof.

The automatic posting step can utilize various templates and/or formats for the automatically generated advertisements and/or listings. For example, the template component 302 can provide standardized templates, user-defined templates, and/or standardized templates edited by a user. Moreover, the template can provide a service, community, and/or a forum which allows various users to share, distribute, sell, etc. templates (e.g., template sharing, template distribution, template sharing, template purchasing, template tips, template techniques, template creation help, or template assistance). It is to be appreciated that any suitable templates can be utilized with the automatic posting module, wherein such templates can be based on various factors such as, but not limited to, image type, image size, item, good, service, target environment, target audience, type/nature of posting or advertisement, cost, terms, geographic location, device used to capture image data, any suitable characteristic related to an advertisement, etc. For example, a specific template can relate to used goods/items that are to be sold by a particular user on an auction website in which the template includes optimal characteristics (e.g., font, size, image location, layout, text layout, organization of descriptive data, etc.) and/or seller/owner information (e.g., location, shipping costs, terms of sale, user profile, user rating, etc.).

The automatic posting module can ascertain geographic data related to the received image data. The location module (GPS) can utilize any suitable technique to identify a geographic location associated with a good and/or service to which image data relates, wherein the technique can be, but is not limited to: a global positioning system (GPS), phone number geographic tracking, triangulation, location registry, cell tower location, user-informed location data, location registration based upon image capture, etc. The location data can be associated with at least one of the good, the service, a seller, an owner, a user profile, a user location, a residence, or a place of business, etc. Moreover, upon identifying the location associated with a captured image (e.g., still picture data, video data, etc.), the system 300 can populate and/or annotate the generated advertisement and/or listing with such geographic data.

For example, a user can take a picture or video showing the condition or configurations of the truck with his/her camera device (e.g., smartphone, digital camera, portable digital device (PDA), laptop, etc.). The geographic location can be determined or approximated by at least one of global positioning system (GPS) or phone number association associated with the device or from his user profile (e.g., preset location). If more than one location is indicated, the user can select the desired location for each particular item. As discussed, descriptive data can be automatically populated for the advertisement and/or listing. For instance, the descriptive data can be populated by at least one of the following: receiving audio input from the user and converting such speech to text; dynamically extracting key words from text and filing in fields; utilizing a service to provide descriptive data; user-defined descriptive data.

In one implementation, the data store can include automatic posting settings, configuration data related to the advertisement/listing, templates, location, user profiles, distribution lists, environment lists, environment settings, publishing settings, historic data related to advertisements/listings, advertisements, listings, postings, image data, video data, format data, layout data, descriptive data, any suitable data related to the system 300, any data related to commerce, and/or any suitable data related to a transaction, etc.

It is to be appreciated that the data store can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 306 of the subject systems and methods is intended to comprise, without being limited to, these and any other suitable types of memory. In addition, it is to be appreciated that the data store 306 can be a server, a database, a hard drive, and the like.

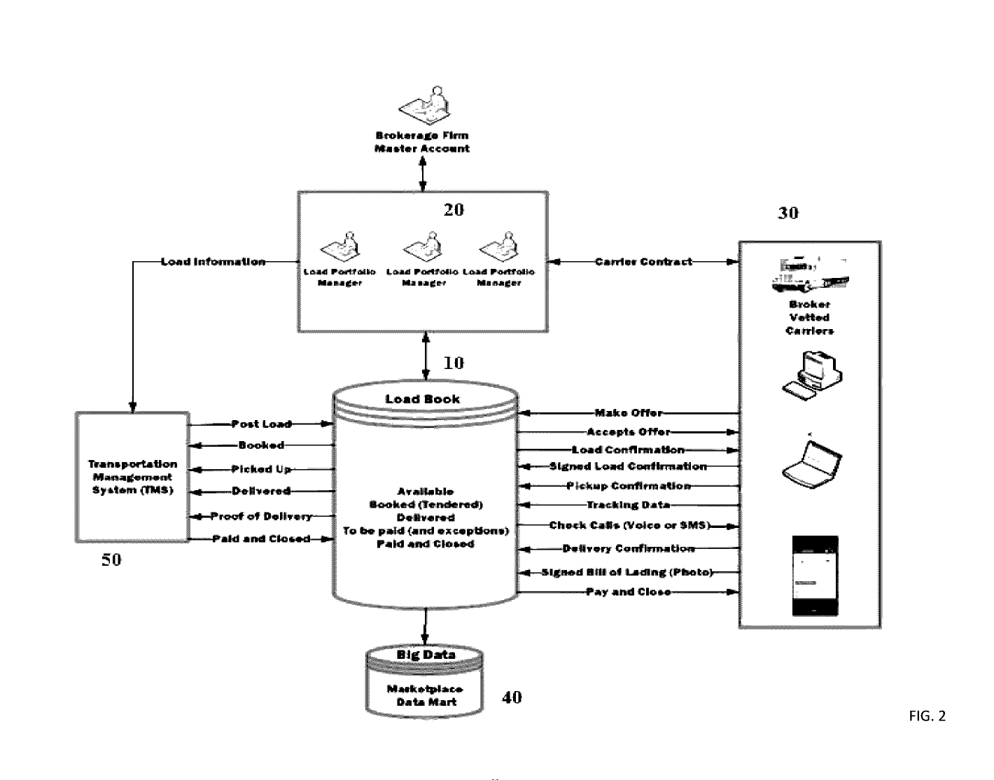

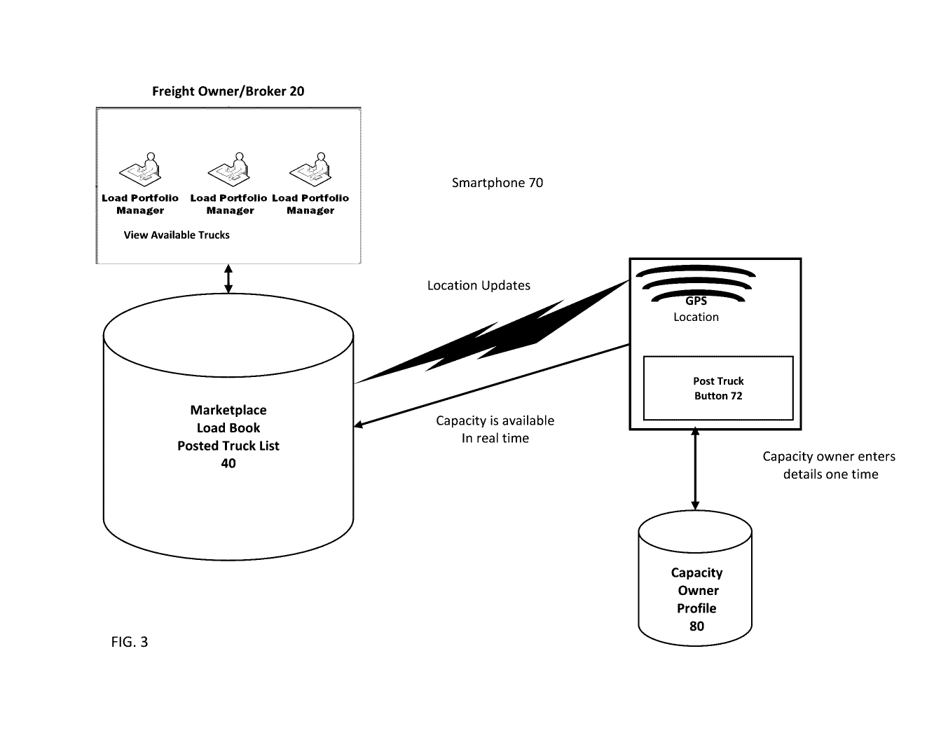

FIG. 2 is a network diagram depicting an online shipping service transaction processing system for an automated transportation marketplace while FIG. 3 shows an exemplary system to capture truck profiles for the marketplace load book. Turning now to FIG. 2, a load book 10 captures available loads for pick up, booked loads, delivered loads, deliveries waiting for payment, and paid/closed cases. The load book 10 is reviewed by a broker, which in turn can have sub-accounts each with a load portfolio manager, for example. The load book 10 also communicates with a plurality of carriers 30 through desktop computers, mobile computers, smart phones, among others. The carriers 30 can interact with the broker 20 to form contract directly, or can communicate through the load book 10 to offer and make/accept the offers. The carriers can also communicate load confirmation, pick up confirmation, provide tracking dta, check calls, provide delivery confirmation, signsbill of lading, and receive payments to close out a contract, among others. The load book 10 and the broker 20 can load data into a customer transportation management system (TMS) 50 to post loads, receive load booking, receive pick-up and delivery information, and pay/close a shipping case.

The load book 10 communicates with a market place data mart 40 which provides profiles of truckers, among others. The marketplace 40 of FIG. 1B receives location updates from each truck as the truck moves. Alternatively, the location can be communicated when a driver posts his/her location using a post truck button 72 on a smart phone 70 running an application thereon. The application also captures truck capacity and owner profiles, and such information is wirelessly uploaded to the marketplace 40. The profile information is typically entered once, and the capacity information can be entered once, and available capacity can be periodically updated depending on the utilization of the truck during a particular trip, for example. Using wireless communication protocols, location update and capacity information can be updated in real-time. In one embodiment, the trucker inputs the information on his/her capacity into a template supplied by the load board and may include type of equipment, amount of deadhead mileage the owner is willing to travel to position the capacity to the origin of the load, current location of the capacity and where the owner of the capacity would like for the capacity to end up.

The automated transportation system can employ a client-server architecture, but it is not limited to such an architecture, and could equally well find application in a distributed, or peer-to-peer, architecture system. The various marketplace and payment applications also be implemented as standalone software programs, which do not necessarily have networking capabilities.

The web client can access various marketplace and payment applications via the web interface supported by the load book 10. Similarly, a programmatic client accesses the various services and functions provided by the marketplace and payment. The programmatic client may, for example, be a trucking application (e.g., the TruckerPath application developed by TruckerPath Inc., of San Jose, Calif.) to enable truckers to author and manage truck service listings on the marketplace 40 in an off-line manner, and to perform batch-mode communications between the programmatic client 30 and the network-based marketplace 40.

In one embodiment, the system of FIGS. 2-3 collects information in advance from the capacity owner, who would note the type of equipment, the desired amount of deadhead miles needed to reposition the equipment, the desired destination and the amount the capacity owner needed to be profitable when moving the freight. With this information already captured and stored in a carefully designed web based platform, the capacity owner's exact location is gleaned from his/her smartphone (or electronic handheld device) and then would be transmitted to the freight owner through the available cell network to the freight owners web portal with ‘one click’ of a digital button on the capacity owner's handheld device. Thus the capacity owner would post his/her available capacity to a transportation marketplace with a large number of freight owner members in a matter of milliseconds making the capacity available for use by a ready and willing freight owner population. In addition, should the capacity owner reposition his/her truck, the GPS would track the smartphone location and transmit it back to the transportation marketplace, keeping the freight owners up to date on the location of the empty capacity.

Truckers and customers/brokers who have entered into a transaction can rate each other at the end of the transaction. A Feedback score is then attached to each member profile. The Feedback score is one of the most important pieces of a Feedback Profile. The Feedback score is the number in parentheses next to a member's username, and is also located at the top of the Feedback Profile. Next to the Feedback score, the user or member may also see an icon such as a truck with colors. The number of positive, negative, and neutral Feedback ratings a member has received over time are part of the Feedback score. For each transaction, truckers and shippers/brokers can choose to rate each other by leaving Feedback. Shippers/Brokers can leave a positive, negative, or a neutral rating, plus a short comment. Truckers can leave a positive rating and a short comment.

The system can support one or more features or functions on a website hosted by the third party. The third party website may, for example, provide one or more promotional, marketplace or payment functions that are supported by the relevant applications of the network-based marketplace.

The network-based marketplace 40 itself, or one or more parties that transact via the marketplace, may operate loyalty programs that are supported by one or more loyalty/promotions applications. For example, a shipper or broker may earn loyalty or promotions points for each transaction established and/or concluded with a particular trucker or carrier, and be offered a reward for which accumulated loyalty points can be redeemed.

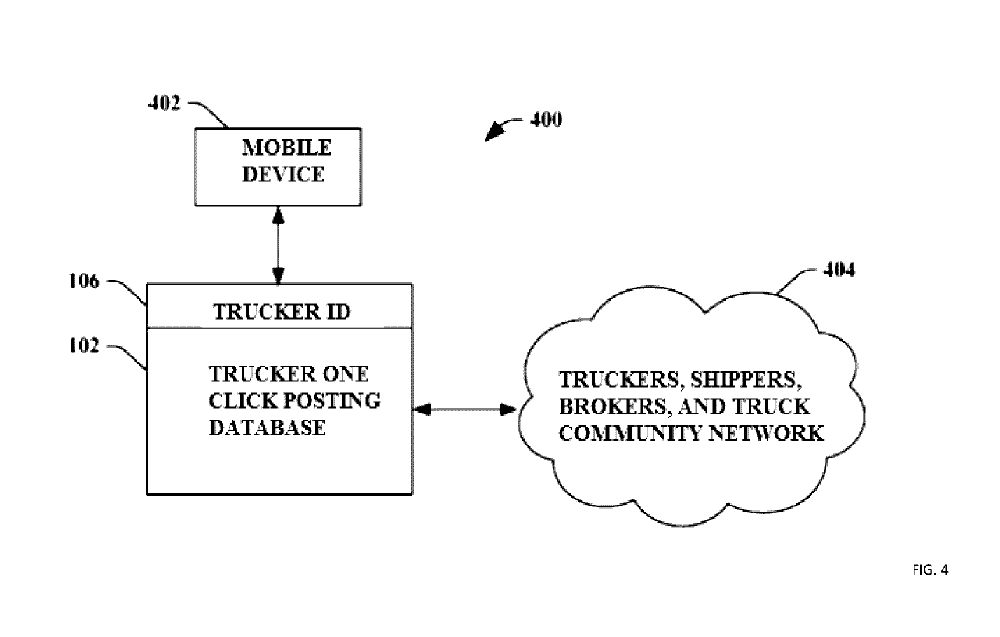

FIG. 4 illustrates a system 400 that facilitates listing a portion of data from a device to an online community network. The system 400 can employ the automatic posting component 102 to receive image data (e.g., video data, still picture data, etc.) captured by a device 402. The device 402 can be any suitable device that can capture image data or video data such as, but not limited to, a camera, a camera portable device, a video camera, a video device, a camera cellular phone, a portable digital assistant, a laptop, a smartphone, a hand-held device, a camera-based computing device, a mobile communications device, a portable device, a device including a camera, a web-cam, a desktop camera device, etc. Moreover, the device 402 can capture image data in any suitable format such as, but not limited to, a video format, a device-specific file format, Joint Photographic Experts Group (JPEG), Bitmap, Portable Network Graphics (PNG), Tagged Image File Format (TIF), Graphics Interchange Format (GIF), metafile, etc. Although the automatic posting component 102 is depicted as a stand-alone component, it is to be appreciated that the automatic posting component 102 can be incorporated into the device 402. For example, the device 402 can include the “one-click” feature and/or technique to allow the automatic capturing of trucker related information, generating an advertisement with descriptive data, and posting and/or publishing such advertisement.

The automatic posting component 102 can receive the trucker data, along with any image data (e.g., video data, picture data, etc.) via the interface 106, wherein an advertisement and/or listing can be automatically created with descriptive data and published to an environment such as a community network 404. The community network 404 can be a network including at least one client, user, entity, etc. In one example, the community network 404 can be a network associated with commerce and/or transactions related to trucking commerce. In another example, the community network 404 can be a website related to auctioning trucking services, etc. For instance, the automatic posting component 102 can publish and/or expose the automatically created advertisement and/or listing to the community network 404, wherein a client, user, entity, etc. related thereto can be targeted with such advertising. By implementing the automatic posting component 102, posting a listing or an advertisement to the community network 404 is greatly enhanced and simplified by reducing manual intervention with the “one-click” feature. In one embodiment, the system employs intelligence to facilitate automatically generating an advertisement for online posting and/or listing. The automatic posting module 102 can facilitate creating an advertisement, describing the advertisement, and/or publishing/posting the advertisement. For example, the system can infer advertisement descriptive data, layouts, formats, image data, transactional details, terms of sale, geographic location, etc.

It is to be understood that the system can perform reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter. The automatic posting module can further utilize a presentation layer that provides various types of user interfaces to facilitate interaction between a user and any component coupled to the automatic posting. As depicted, the presentation layer is a separate entity that can be utilized with the automatic posting. The presentation layer can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled to and/or incorporated into the automatic posting.

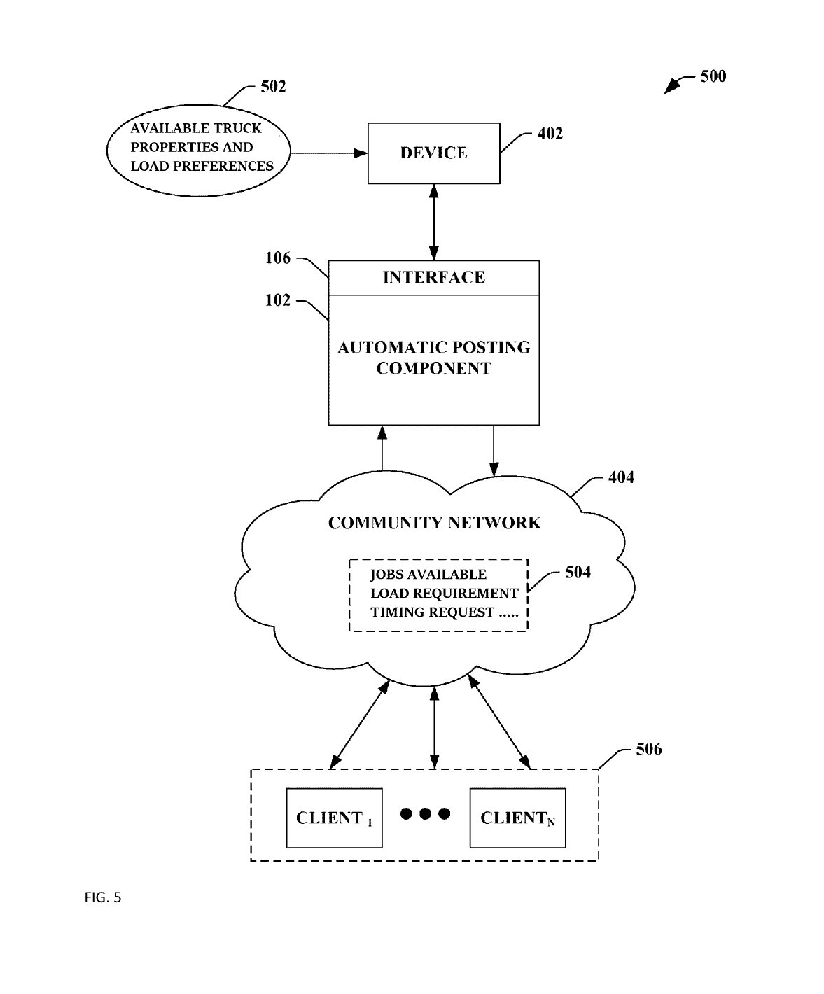

FIG. 5 illustrates a system 500 that facilitates automatically generating an advertisement that is exposed to the Internet based at least in part upon image data captured by a device. The system 500 can include the automatic posting component 102 that can receive image data from the device 402 via the interface 106 to automatically create an advertisement and/or a posting for exposure and/or publishing to an online environment. In general, the automatic posting component 102 can implement a “one-click” technique which can allow the automatic capturing of an image or video, the creation of an advertisement for the image, population of descriptive data for the image, and posting of the advertisement to an environment. As discussed, such “one-click” technique and/or feature can be implemented with the device 402 and/or any suitable camera-based device or video-based device.

The device 402 can capture image data (e.g., video data, picture data, etc.) related to a trucking service 502 that is to be advertised based at least in part upon the activation of the “one-click” feature and/or technique. Once captured, the automatic posting component 102 can create an advertisement 504 for the captured trucker data. For example, the format and/or layout of the advertisement 504 can be based upon a template (e.g., standardized, user-defined, user-defined standard template, etc.), wherein such advertisement 504 can be populated with descriptive data automatically, manually, and/or any suitable combination thereof. Once created, the advertisement 504 can be published to an environment such as, for instance, the community network 404 having clients 506. It is to be appreciated that there can be any suitable number of clients 506 such as client 1 to client N, where N is a positive integer. Furthermore, as discussed above, the automatic posting component 102 can selectively publish the advertisement 504 such that a portion of the clients 506 can be exposed and/or access the advertisement 504.

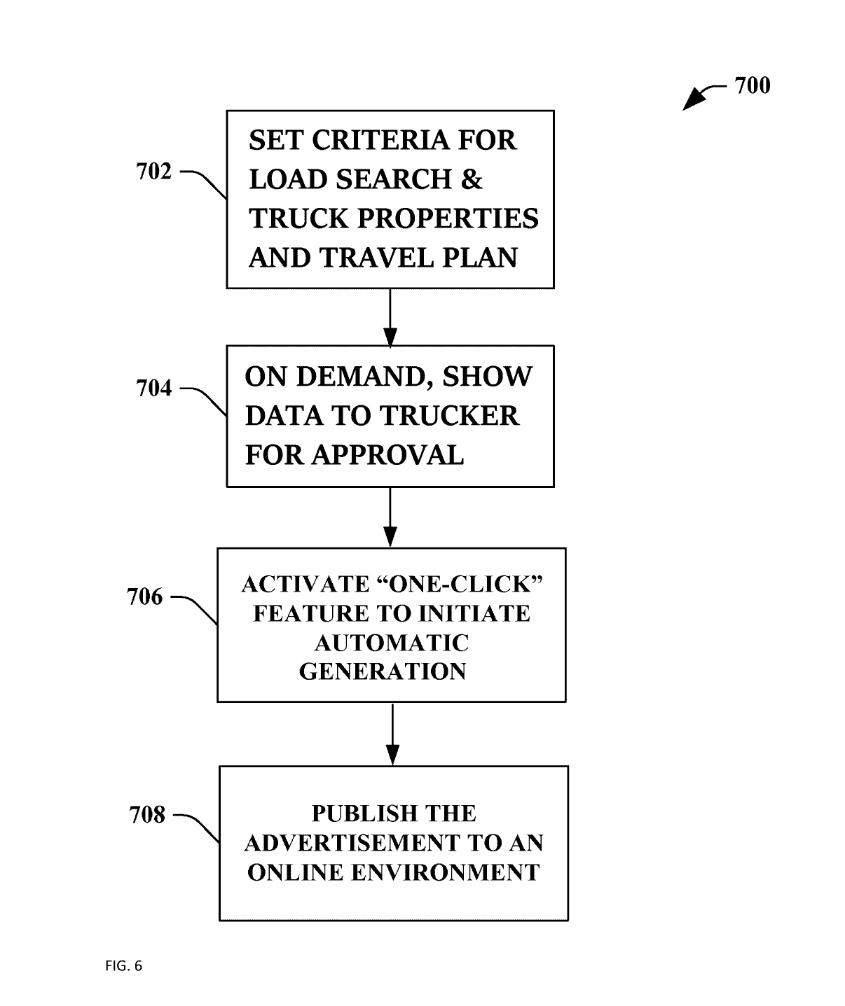

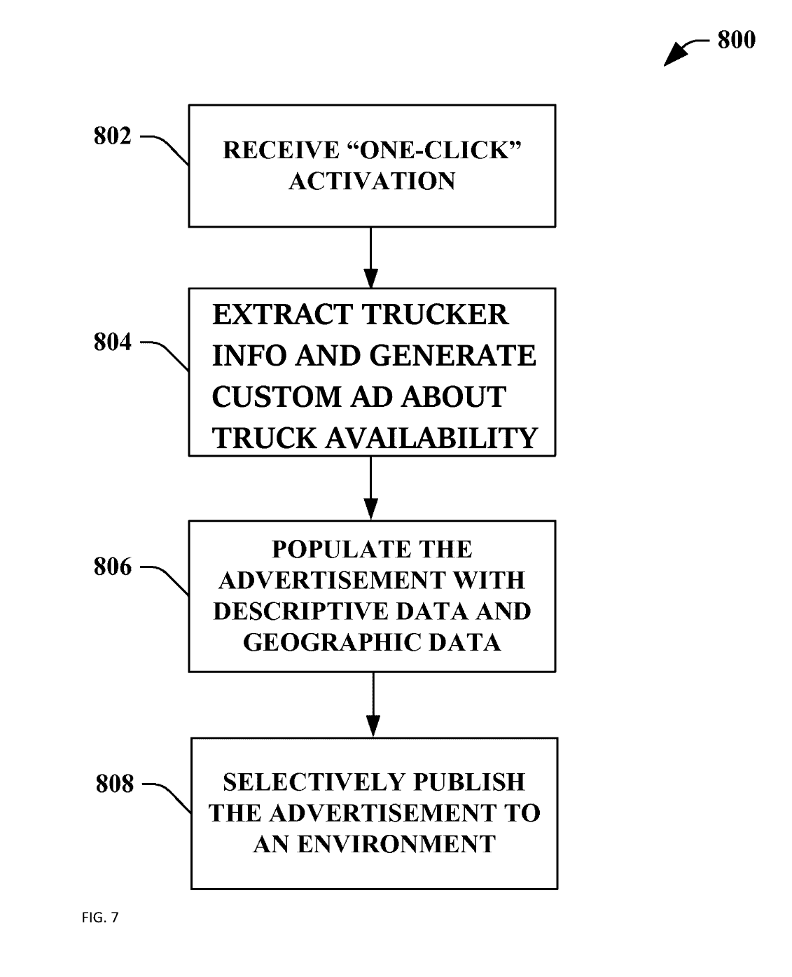

FIGS. 6-7 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a methodology 700 for automatically generating an advertisement that is exposed to the Internet based at least in part upon image data captured by a device. At reference numeral 702, a “one-click” feature can be activated to initiate an automatic advertisement generation. The “one-click” feature can be any suitable activation associated with capturing an image and automatically creating an advertisement related thereto. In addition, it is to be appreciated that the “one-click” feature need not be a “click” activation but rather can be any suitable activation such as, but not limited to, a button, a voice command, a switch, a touch-button, a touch-screen activation, a motion detection activation, a timer delayed switch/button, a slider, etc.

At reference numeral 704, image data (e.g., still picture data, video data, etc.) can be captured based at least in part upon the activation of the “one-click” feature. The image data can be captured by any suitable device that can collect and/or capture images or video. Furthermore, it is to be appreciated that the image data captured can be related to any suitable good/service associated with a transaction.

At reference numeral 706, an advertisement with descriptive data can be created utilizing the image data. The advertisement can be automatically created for the image or collection of images (e.g., video, etc.), wherein the advertisement can be populated and/or annotated with descriptive data. For example, the descriptive data can be text, additional images, contact information, sale price, transaction details, shipping information, instruction manuals, product details, manufacturer information, pricing details, terms of sale, seller information, geographic data, profile data, listing field data, or any suitable data related to the image, etc. At reference numeral 708, the advertisement can be published to an online environment. For instance, the online environment can be, but is not limited to being, the Internet, a social network, a network, a networked community, a forum, a website, a blog, an email list server, an email address, a server, a group, a user, a company, a business, etc. Thus, the methodology 700 enables an advertisement to be automatically created, populated with descriptive data, and published to an online environment based upon the activation of the “one-click” feature.

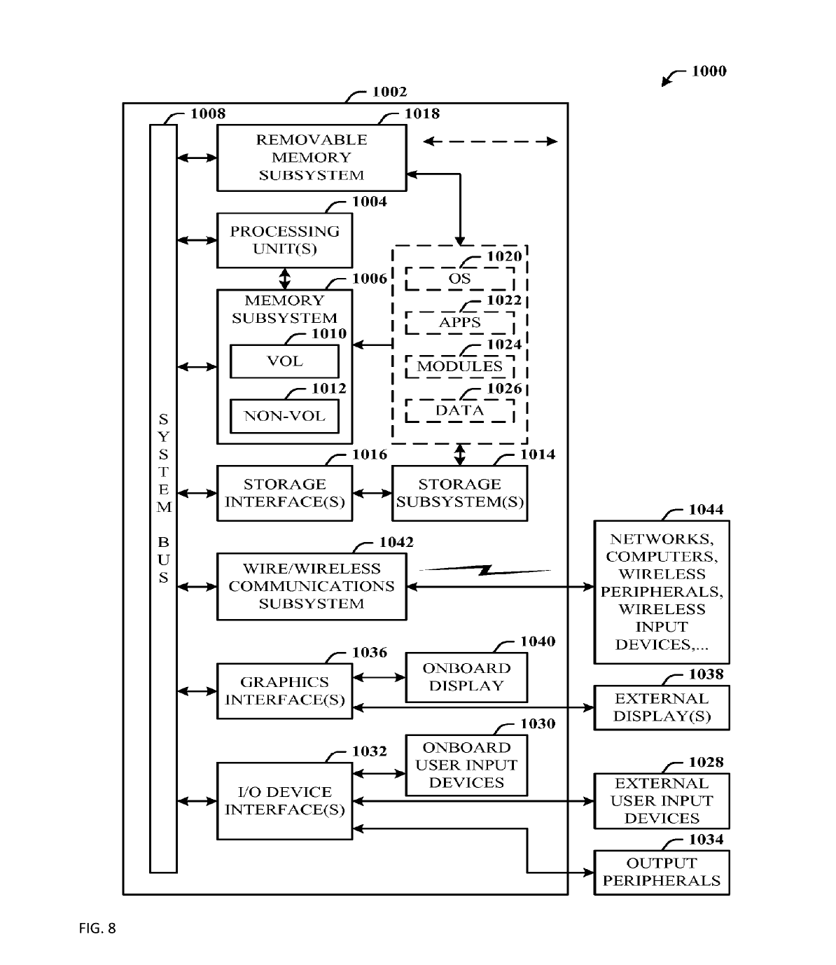

FIG. 8 illustrates a methodology 800 that facilitates annotating and selectively listing a portion of data online for advertisement. At reference numeral 802, an activation can be received such a “one-click” activation. For example, the “one-click” activation can be received by any suitable device with at least one of a camera or image capturing ability. At reference numeral 804, an image can be captured and an advertisement can be automatically generated utilizing a template based on the “one-click” activation. It is to be appreciated that image data can include data related to a picture, a graphic, a video, a portion of video, etc. Moreover, a plurality of images can be captured, wherein the plurality of images can be video data. For instance, standardized templates, user-defined templates, and/or standardized templates edited by a user can be employed to automatically create an advertisement for the captured image. It is to be appreciated that any suitable templates can be utilized, wherein such templates can be based on various factors such as, but not limited to, image type, image size, item, good, service, target environment, target audience, type/nature of posting or advertisement, cost, terms, geographic location, device used to capture image data, any suitable characteristic related to an advertisement, etc. For example, a specific template can relate to rental properties that can be published on a rental property website in which the template includes optimal characteristics (e.g., font, size, image location, layout, etc.).

At reference numeral 806, the advertisement can be populated with descriptive data and geographic data. The descriptive data can be identified and/or generated by at least one of the following: receiving audio input from a user and converting such speech to text; dynamically extracting key words from text and filling appropriate fields; a service that populates data for the captured image; or using pattern recognition on the received image data. Furthermore, the descriptive data can include geographic information related to the location of the product and/or seller. For example, any suitable technique can be implemented to identify a geographic location associated with a good and/or service to which image data relates, wherein the technique can be, but is not limited to: a global positioning system (GPS), phone number geographic tracking, triangulation, location registry, cell tower location, user-informed location data, etc.

At reference numeral 808, the advertisement can be selectively published to an environment. In general, upon automatic creation of the advertisement related to the captured image data (e.g., wherein such creation can be based upon the activation of the “one-click” feature), the advertisement can be published and/or exposed to an online environment such as, but not limited to, the Internet, a network, a networked community, a forum, a website, a blog, an email list server, an email address, a social network, a server, a group, a user, a company, a business, etc. Yet, the advertisement can be selectively published to a particular portion of the environment. In other words, the advertisement can be selectively exposed to selected entities (e.g., users, businesses, groups, machines, computers, websites, networks, servers, email addresses, user profiles, etc.) within the target environment. Thus, the exposure of the advertisement distribution can be limited and/or broadened. For example, an advertisement can be automatically created for a picture of a motorcycle in which such advertisement can be selectively published to members of motorcycle groups on the Internet than exposing such advertisement to every user/client on the Internet.

In order to provide additional context for implementing various aspects of the claimed subject matter, FIGS. 9-10 and the following discussion is intended to provide a brief, general description of a suitable computing environment in which the various aspects of the subject innovation may be implemented. For example, an automatic posting component that facilitates creating an advertisement with descriptive data with minimal user intervention, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

Referring now to FIG. 8, there is illustrated a block diagram of a computing system 1000 that executes automatic discovery of nearby geographic locations in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 10 and the following description are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a computer-readable storage such as a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include computer-readable storage (physical storage media) such as a volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the system memory 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes machine readable storage subsystem(s) 1014 and storage interface(s) 1016 for interfacing the storage subsystem(s) 1014 to the system bus 1008 and other desired computer components. The storage subsystem(s) 1014 (physical storage media) can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a machine readable and removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

When using a mobile phone, the operating system, one or more application programs, other program modules, and/or program data can include entities and components of the system 100 of FIG. 1, entities and components of the system 200 of FIG. 2, entities and components of the system 300 of FIG. 3, the truck driver interface dialog 400 of FIG. 4, the notification dialog 500 of FIG. 5, the flow diagram 600 of FIG. 6, some or all of the entities and components of the pull approach system 700 of FIG. 7, and the methods represented by the flowcharts of FIGS. 8 and 9, for example.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1002 and includes volatile and non-volatile internal and/or external media that is removable or non-removable. For the computer 1002, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A truck driver can interact with the computer 1002, programs, and data using external truck driver input devices 1028 such as a keyboard and a mouse. Other external truck driver input devices 1028 can include a microphone, an IR (infrared) remote control, a joystick, a game pad, camera recognition systems, a stylus pen, touch screen, gesture systems (e.g., eye movement, head movement, etc.), and/or the like. The truck driver can interact with the computer 1002, programs, and data using onboard truck driver input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented method to advertise services from a trucker to an online environment with minimal user intervention, comprising:
capturing trucker data to be sent periodically with a one-click button, wherein the trucker data includes load preference and geo-fence data;
generating a test advertisement to validate the data to be advertised and activating a “one-click” feature to initiate an automatic advertisement generation; and
when the trucker clicks the button at a current truck location, broadcasting the automatically generated advertisement on behalf of the trucker to indicate spatial and temporal availability of the trucker to haul a load near the current truck location.

2. The method of claim 1, comprising capturing truck data from a device based at least in part upon the “one-click” feature, wherein the truck data originates from an image transmitted by a user from an auxiliary device to the device; performing pattern recognition on the truck data to extract descriptive data from the image; creating an advertisement for the captured image data using the descriptive data; populating the advertisement with a portion of descriptive data; and publishing the advertisement to an online environment.

3. The method of claim 1, comprising: receiving audio input from a user and converting the audio input to text to populate the truck advertisement with descriptive truck data; dynamically extracting a key word from text and filling an appropriate field within the truck advertisement.

4. The method of claim 1, comprising: utilizing a template for the truck advertisement to provide at least one of a structure or a layout of data; selectively publishing the truck advertisement to the online environment; ascertaining a portion of geographic data related to the advertisement; and annotating the advertisement to include the portion of geographic data.

5. The method of claim 1, further comprising specifying the category of interest manually or learning the category of interest automatically.

6. The method of claim 1, further comprising applying geo-fencing to select the truck advertisement to a specific area.

7. The method of claim 1, further comprising automatically updating the truck advertisement on behalf of the truck driver based on a detected change in the geographical location of the truck driver device.

8. The method of claim 1, comprising creating and updating a repository that includes the category of interest in association with the truck driver device, geolocation information for movable points of interest, temporary points of interest, and new points of interest.

9. The method of claim 1, comprising capturing available loads for pick up, booked loads, delivered loads, deliveries waiting for payment, and paid/closed cases in a load book for review by a broker.

10. The method of claim 9, comprising communicating with a market place data mart with profiles of truckers, wherein the marketplace receives location updates from each truck as the truck moves.

11. The method of claim 9, wherein the marketplace receives location updates when a driver posts a location using a post truck button on a mobile phone.

12. A computer-implemented system to locate loads for a trucker with minimal user intervention, comprising:
a processor;
memory coupled to the processor, the memory including code to capturing trucker data to be sent periodically with a one-click button, wherein the trucker data includes load and geo-fence data;
code to generate a test query to validate the data to be advertised and activating a “one-click” feature to initiate an automatic load search request; and code, when the trucker clicks the button, to send automatically generated search request on behalf of the trucker to one or more brokers or load aggregation sites and displaying a search result to the trucker to select.

13. The system of claim 12, comprising code for capturing truck data from a device based at least in part upon the “one-click” feature, wherein the truck data originates from an image transmitted by a user from an auxiliary device to the device; performing pattern recognition on the truck data to extract descriptive data from the image; creating an advertisement for the captured image data using the descriptive data; populating the advertisement with a portion of descriptive data; and publishing the advertisement to an online environment.

14. The system of claim 12, comprising code for receiving audio input from a user and converting the audio input to text to populate the truck advertisement with descriptive truck data; dynamically extracting a key word from text and filling an appropriate field within the truck advertisement.

15. The system of claim 12, comprising code for utilizing a template for the truck advertisement to provide at least one of a structure or a layout of data; selectively publishing the truck advertisement to the online environment; ascertaining a portion of geographic data related to the advertisement; and
annotating the advertisement to include the portion of geographic data.

16. The system of claim 12, comprising code for specifying the category of interest manually or learning the category of interest automatically.

17. The system of claim 12, comprising code for applying geo-fencing to select the truck advertisement to a specific area.

18. The system of claim 12, comprising code for automatically updating the truck advertisement on behalf of the truck driver based on a detected change in the geographical location of the truck driver device.

19. The system of claim 12, comprising code for creating and updating a repository that includes the category of interest in association with the truck driver device, geolocation information for movable points of interest, temporary points of interest, and new points of interest.

20. The system of claim 12, comprising code for communicating with a market place data mart with profiles of truckers, wherein the marketplace receives location updates from each truck as the truck moves.
